(19) United States
(12) Patent Application Publication
(10) Pub. No.: US 2018/0134493 A1
(43) Pub. Date: May 17, 2018

(54) COLLAPSIBLE MUG HANDLE

(71) Applicant: China 2 West Services Ltd, Zhuhai (CN)

(72) Inventors: Andrew N. Cunningham, Freeport (BS); Mark K. Jacobs, Xin Xiangzhou (CN); Mark Clayton, Zhuhai (CN)

(73) Assignee: China 2 West Services Ltd, Zhuhai (CN)

(21) Appl. No.: 15/349,884

(22) Filed: Nov. 11, 2016

(51) Int. Cl. B65G 7/12; A47G 23/02

(52) U.S. Cl. CPC B65G 7/12; A47G 23/0216

(57) ABSTRACT

A removable handle operable to convert a commercially available glass to a mug. An exemplary handle includes a pair of spaced-apart rings in which to receive the glass. One or more of the rings may be incomplete, or interrupted in circumference, to provide accommodation to variance in size of a drink container (e.g., a glass, such as a Stainless Steel double-walled thermal cup). The rings fold with respect to the handle from a deployed configuration to a stored configuration having a reduced storage space requirement.

### BACKGROUND

### Field of the Invention

This invention relates to removable handles that may be used to hold and manipulate an object. It is particularly directed to a collapsible handle that may be used in conjunction with a commercially available beverage container effective to convert the container from a glass to a mug.

### State of the Art

It is known in the art to provide removable handles for various containers, such as for containers adapted to dispense fluid. Exemplary such containers include bulk dispensing packages such as milk cartons and oil cans, as well as individual drinking vessels including cups, and other beverage containers such as soda or beer cans. A number of removable handles are disclosed in U.S. utility patent Nos. 2,215,402; 2,305,628; 3,458,164; 4,120,073; 4,741,073; 6,729,665; and 7,080,753. Additional removable handles are disclosed in U.S. published utility patent application Nos. 2015/50274300; and 2016/0038375. A removable handle structured to hold a bulk container is disclosed in International patent application No. WO 2009/110789. The entire disclosures of the above-listed documents are hereby incorporated by reference in this disclosure for their teachings of removable handles and structures operable to interface with various containers having different shapes, form factors, and materials of construction.

### BRIEF SUMMARY OF THE INVENTION

This invention may be embodied to provide a mug handle assembly including an anchor, a holder, and an anchor. An operable anchor typically carries a first connector and is structured to removably couple with a drink container at a first location. An operable holder typically carries a second connector and is structured to removably couple with the drink container at a second location that is spaced apart from the first location.

A workable handle has a first end and a second end, with structure carried at the first end being configured and arranged in harmony with the first connector to form a first hinge, structure carried at the second end being configured and arranged in harmony with the second connector to form a second hinge. The first hinge, second hinge, and handle are generally structured to permit a user to collapse the handle assembly from a deployed configuration to a stored configuration such that the holder is disposed on one side of the handle at the deployed configuration and is disposed on the opposite side of the handle at the stored configuration, and the handle assembly then occupies a minimum volume at the stored configuration.

The holder is generally disposed on the same side of the anchor at both the stored configuration and the deployed configuration. Also, the anchor may be disposed on one side of the holder at the stored configuration and on the opposite side of the holder when at the deployed configuration. The deployed configuration typically occupies a larger volume than the stored configuration. In certain embodiments, the holder is approximately parallel to the anchor at both the deployed configuration and the stored configuration.

A workable first hinge includes a tongue-and-groove pinned joint. A workable second hinge also includes a tongue-and-groove pinned joint. One operable anchor includes a stop element defining an uninterrupted first perimeter, the stop element being structured to resist displacement of the container in a direction away from the holder. In some embodiments, the holder includes a gripping element defining an interrupted second perimeter, the gripping element being resilient to deflect and enlarge a size of the gripping element to accommodate containers having different sizes. Sometimes, an opening in the second perimeter is disposed opposite the handle.

The anchor may include a circumferentially continuous first ring element. The holder may include a circumferentially-interrupted second ring element, the second ring element being resilient to deflect and enlarge an inside diameter of the second ring element to accommodate containers having different sizes. A preferred holder has elasticity to permit a user to cause a bias in the holder, and thereby, generate a compression force at a contact interface area between the holder and an installed container. Sometimes, the bias is a bending moment that causes substantially uniform pressure to be distributed over the contact interface area.

An embodiment may also include an angled extension member extending between the holder and the second hinge effective to dispose the second hinge at an enhanced remote location on an opposite side of a plane, defined by structure of the top surface of the holder, from the anchor. The angled member may be configured in harmony with the handle to permit a user to apply thumb pressure, from a hand that is gripping the handle, on a top surface of the angled member effective to cause the anchor and the holder to apply an auxiliary clamping torque on the container.

In certain embodiments, the handle may include a textured surface structured to reduce slipperiness when gripped in a user's hand. One workable textured surface includes a plurality of parallel ribs distributed along a length axis of the handle. An embodiment may include one or more decorative cover adapted to conceal axle structure of the first hinge and/or the second hinge from casual sight of a user.

An anchor may be structured for rotation between deployed and stowed configurations, and with respect to the handle, by an angle including about 100 degrees, or so. A holder can be structured for rotation between deployed and stowed configurations, and with respect to the handle, by an angle including about 280 degrees, or so.

The invention may be embodied to provide an improved and removable collapsible handle assembly that can be applied to a drinking vessel to make a mug. Part of the improvement may include a top holder defining a first interior space in which to receive the drinking vessel by inserting the drinking vessel in a direction parallel to a length axis of the drinking vessel, the top holder carrying an angled extension member configured to dispose a top hinge above a plane defined by structure of the top surface of the top holder, and a bottom anchor structurally associated with a bottom hinge, the bottom anchor being configured to resist displacement of the drinking vessel beyond an installed position and in a direction way from the top holder, and with a handle connected between the top hinge and the bottom hinge. Desirably, the top hinge, bottom hinge, and handle are structured to permit a user to collapse the handle from a deployed configuration to a stored configuration such that the top holder is disposed on one side of the handle at the deployed configuration and is disposed on the opposite side of the handle at the stored configuration, and the handle assembly occupies a minimum volume at the stored configuration.

### BRIEF DESCRIPTION OF THE DRAWINGS

In the drawings, which illustrate what are currently considered to be the best modes for carrying out the invention:

FIG. 1 is a side view of a preferred embodiment in deployed association with a generic drinking vessel;

FIG. 2 is a perspective view of the embodiment in FIG. 1 in a stored configuration;

FIG. 3 is a perspective view from the front and above of the embodiment in FIG. 1 in a deployed configuration;

FIG. 4 is a perspective view from the rear of the embodiment in FIG. 1 in a stored configuration;

FIG. 5 is a perspective view from the rear and above of the embodiment in FIG. 1 in a deployed configuration;

FIG. 6 is a front view of the embodiment in FIG. 1 in a stored configuration;

FIG. 7 is a front view of the embodiment in FIG. 1 in a deployed configuration;

FIG. 8 is a side view of the embodiment in FIG. 1 in a stored configuration;

FIG. 9 is a side view of the embodiment in FIG. 1 in a deployed configuration;

FIG. 10 is a rear view of the embodiment in FIG. 1 in a stored configuration;

FIG. 11 is a rear view of the embodiment in FIG. 1 in a deployed configuration;

FIG. 12 is a bottom view of the embodiment in FIG. 1 in a stored configuration;

FIG. 13 is a top view of the embodiment in FIG. 1 in a deployed configuration;

FIG. 14 is a top view of the embodiment in FIG. 1 in a stored configuration;

FIG. 15 is a bottom view of the embodiment in FIG. 1 in a deployed configuration;

FIG. 16 is a composite side view of the embodiment in FIG. 1 being moved between a deployed configuration and a stored configuration;

FIG. 17 is a side view of the embodiment in FIG. 1 illustrating articulation angles of components;

FIG. 18 is a front left-side view in perspective from above of an alternative embodiment;

FIG. 19 is a front right-side view in perspective from above of the embodiment in FIG. 18;

FIGS. 20 through 31 illustrate self-evident views similar to those presented in FIGS. 1-17 of an alternative embodiment; and

FIGS. 32 through 48 illustrate self-evident views similar to those presented in FIGS. 1-17 of an alternative embodiment.

### DETAILED DESCRIPTION OF THE ILLUSTRATED EMBODIMENTS

Reference will now be made to the drawings in which the various elements of the illustrated embodiments will be given numerical designations and in which the invention will be discussed so as to enable one skilled in the art to make and use the invention. It is to be understood that the following description is only exemplary of certain principles of the present invention, and should not be viewed as narrowing the claims which follow.

An embodiment of a removable handle assembly structured according to certain principles of the invention is indicated generally at 100 in FIG. 1. Handle assembly 100 in FIG. 1 is illustrated in operable installed position on a generic and commercially available drinking cup, tumbler, or vessel 104. Cup 104 is representative of, for example, a 20 oz. double-walled Stainless Steel vacuum insulated personal beverage cup. A plurality of such cups 104 are commercially available, and nonexclusively include containers sold under the brand names Yeti (yeti.com), Kodiak (kodiak-coolers.com/), RTIC (rticcoolers.com), SIC (siccups.com), and Ozark Trail (walmart.com). Of course, it is to be understood that a handle 100 may be configured to hold a cup 104 that is selected from cups having a variety of volume capacities, not only 20 or 30 oz., and not only cups having a substantially cylindrical or frustoconical tumbler shape.

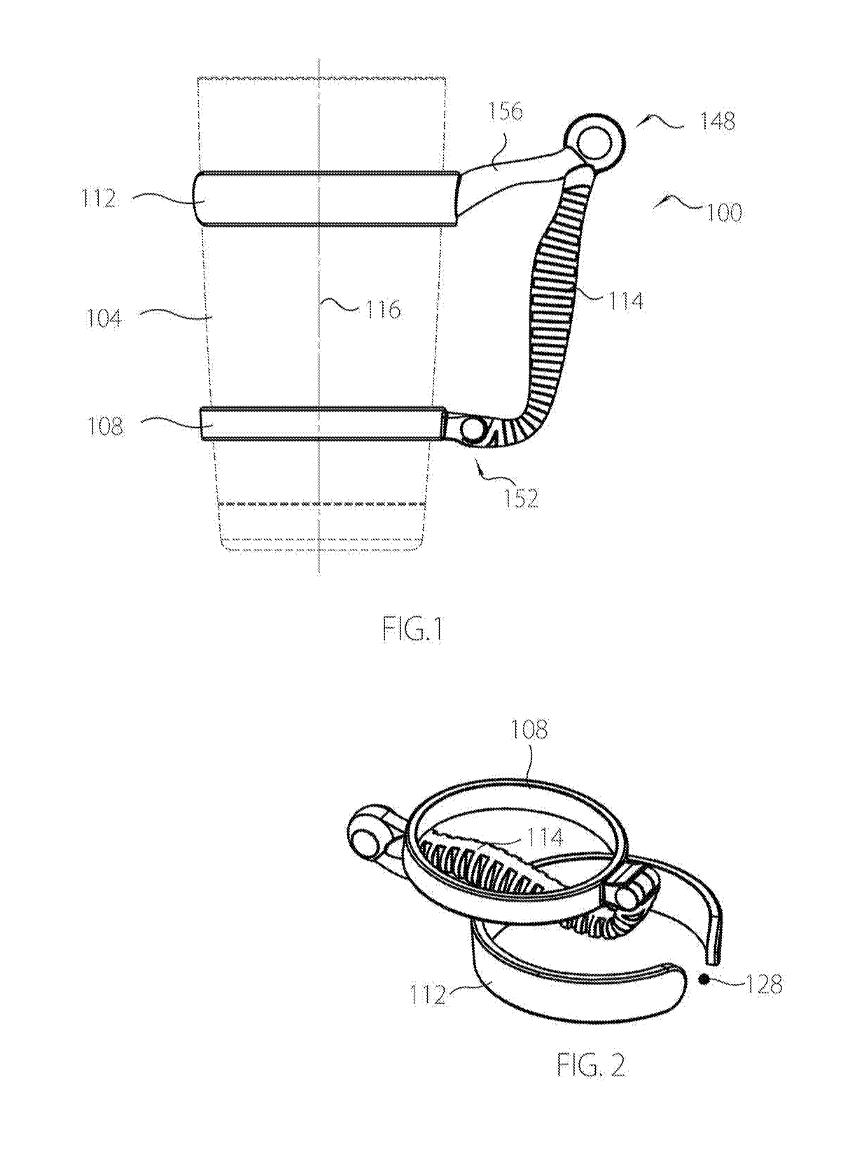

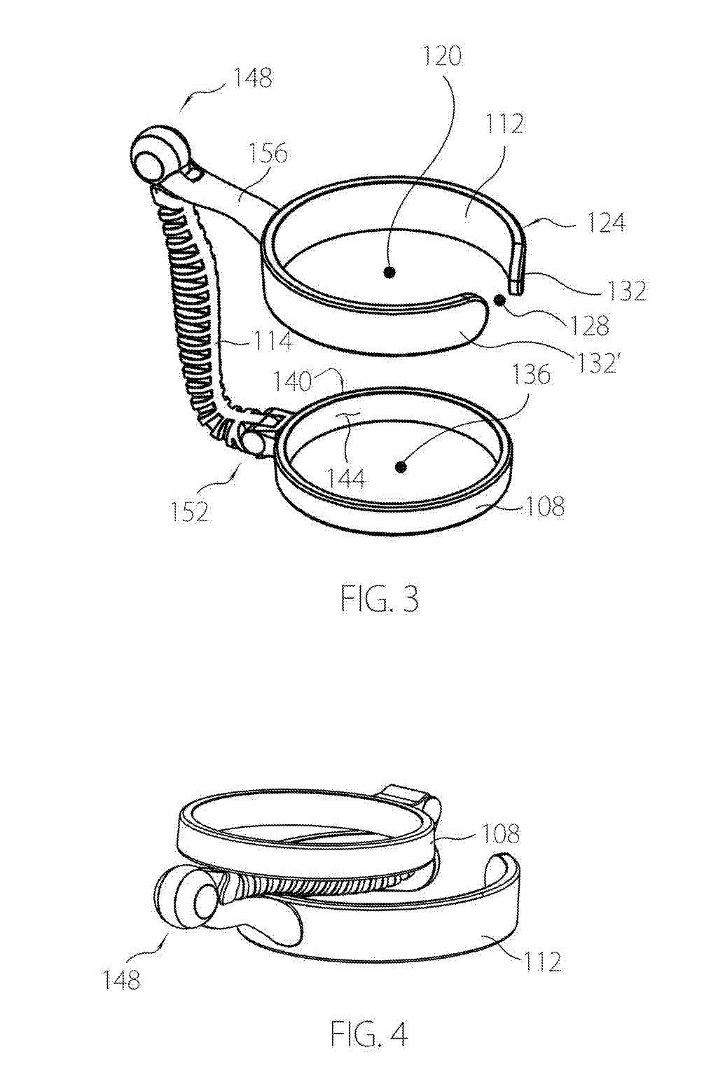

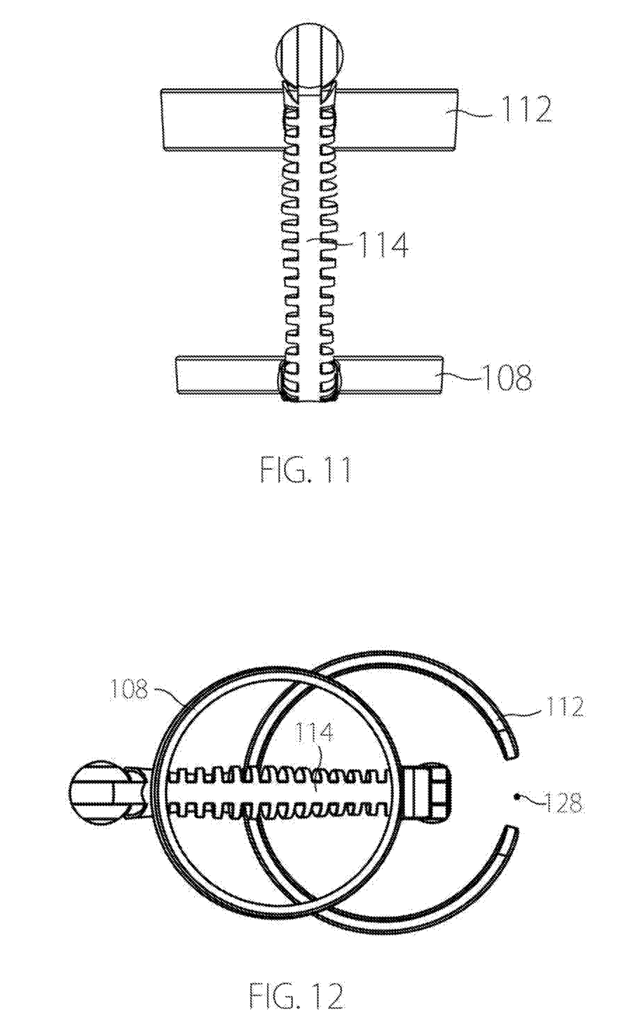

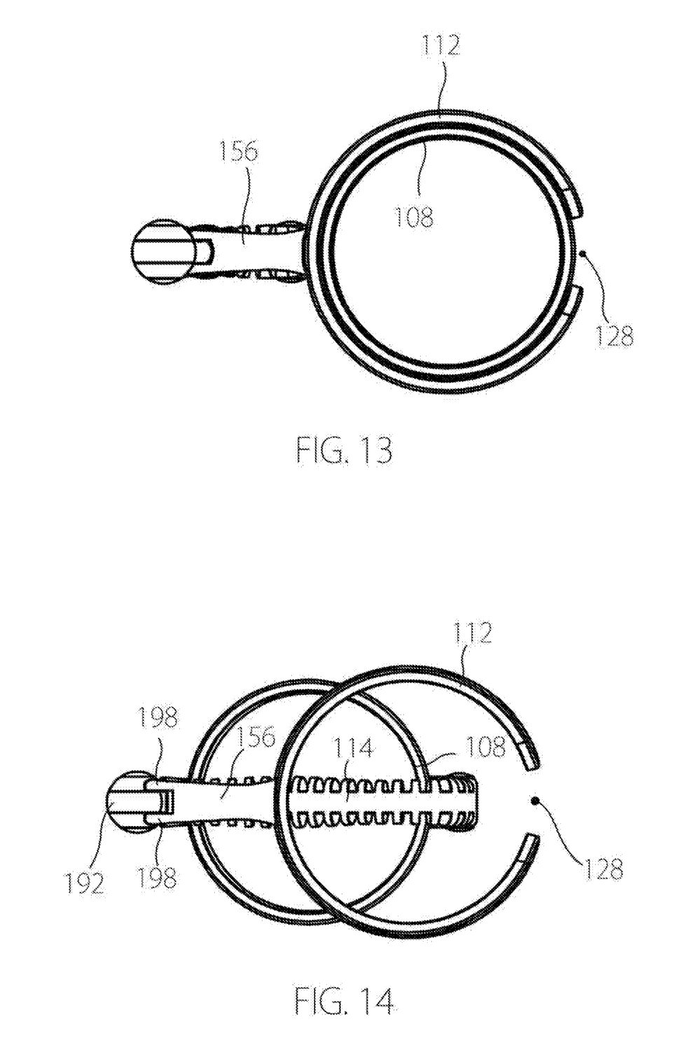

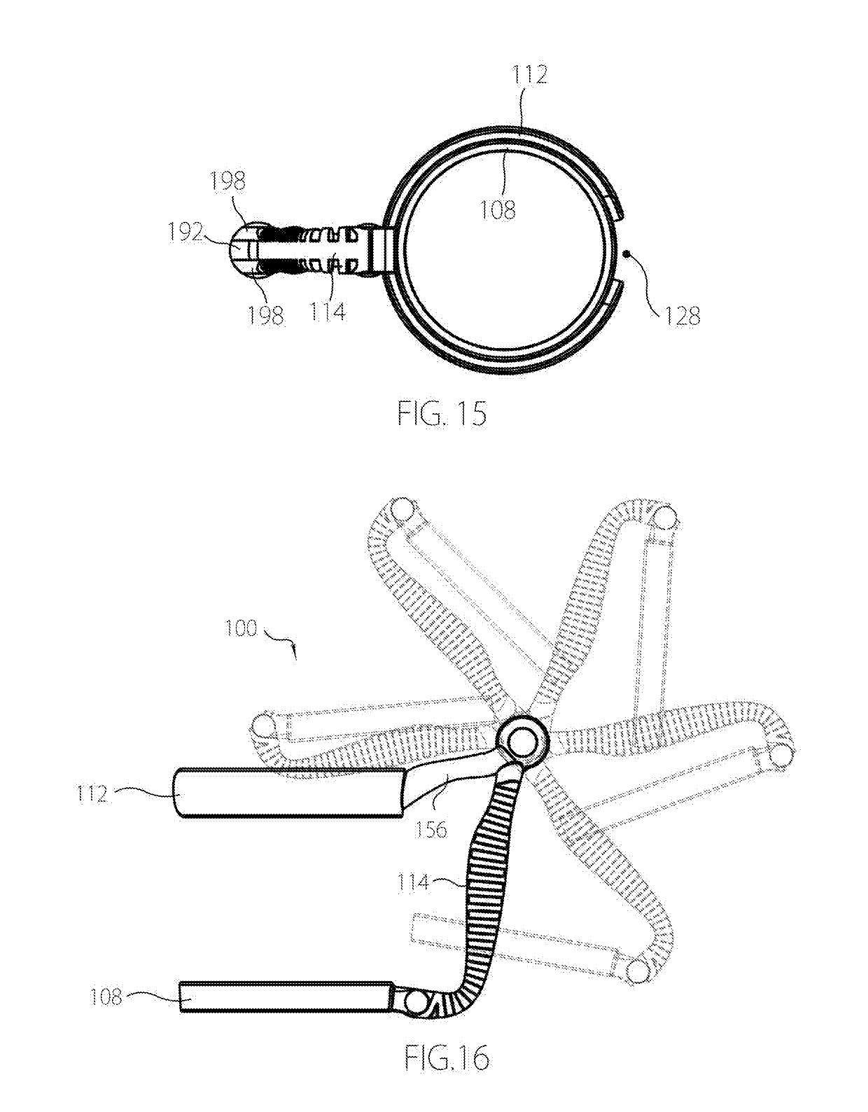

As illustrated in FIGS. 1-17, handle assembly 100 includes an anchor 108 and a holder 112, which may be variably spaced apart by a handle 114. Exemplary FIG. 2 illustrates handle assembly 100 in a stored configuration at which handle assembly 100 occupies a minimum volume. Exemplary FIGS. 1 and 3 illustrate the handle assembly 100 in a deployed configuration, which occupies a larger volume. A cup 104 may be installed in a deployed handle assembly 100 by inserting the cup 104, in a direction parallel to length axis 116 of the cup 104, for reception of a portion of the cup 104 in a receiving space 120 defined by holder 112. With reference to FIG. 1, the holder 112 and the anchor 108 may be removably coupled to the cup 104 at spaced apart locations.

Illustrated holder 112 may be characterized as a circumferentially-interrupted ring element. That is, the perimeter or circumference 124 is interrupted by an opening 128. Desirably, opening 128 is disposed opposite the handle 114. In that construction, holder 112 provides a pair of similar arms 132 and 132′. Arms 132, 132′ may be characterized as cantilevered curved beam elements. It is within contemplation that an alternative holder 112 may suggest a different shape than ring-like or circular, such as rectangular for one non-limiting example.

Typically, installation of a cup 104 causes a deflection of arms 132, 132′ and generates a bias in the arms operable to grip the cup 104. Also, deflection of the arms 132, 132′ facilitates coupling the handle assembly 100 to containers having slightly different sizes, and increases dimensional tolerance during manufacturing of a holder 112. Desirably, holder 112 is formed from one or more materials that has/have resiliency and/or elasticity to permit a user to cause a bias in the holder arms 132, 132′, and thereby, generate a compression force at a contact interface area between the holder 112 and an installed container. In a preferred embodiment, the bias includes a bending moment in arms 132, 132′ that causes substantially uniform pressure to be distributed over the contact interface area. Also, a coating or surface treatment may be applied to increase friction and holding force between the holder 112 and a cup 104 or other vessel.

It is within contemplation that an alternative holder 112 may be structured to permit installation of a cup 104 in different ways. For example, a workable alternative holder 112 may be configured to permit a transverse snap-on arrangement effective to couple a holder 112 to a cup 104, or a cylindrical can or other straight-walled vessel (not illustrated). In this alternative case, opening 128 would be sized closer to, but still less than, a diameter of the vessel.

An operable anchor 108 is structured to resist displacement of a cup 104 beyond an installed position and in an installation direction away from the holder 112. The anchor 108 illustrated in e.g. FIG. 3 is structured as an uninterrupted ring element, which defines an interior receiving space 136 sized and arranged to receive and support a cup 104 or other vessel. A cup 104 may be inserted into space 136 until the sidewall of the cup 104 is placed into contact with the perimeter or circumference 140 or, preferably, with contact interface surface 144. It is within contemplation that an anchor 108 may be structured in alternative ways. For non-limiting example, an anchor 108 may include a floor (not illustrated) to support the bottom of a cup or vessel. Further, an anchor 108 need not be circular, or uninterrupted, or even define a receiving space 136. A workable anchor 108 may be embodied as a simple flat shelf, or any other sort of stop element structured to resist displacement of the container beyond an installed position and in a direction away from the holder.

Desirably, handle 114 is connected to the holder 112 and the anchor 108 in a manner that permits the anchor 108 and holder 112 to rotate or otherwise move with respect to the handle 114 between a stored configuration (e.g., FIG. 2) and a deployed configuration (e.g., FIG. 1). The handle 114 illustrated in FIG. 1 is attached to holder 112 at a top hinge, generally 148, and is attached to anchor 108 at a bottom hinge, generally 152.

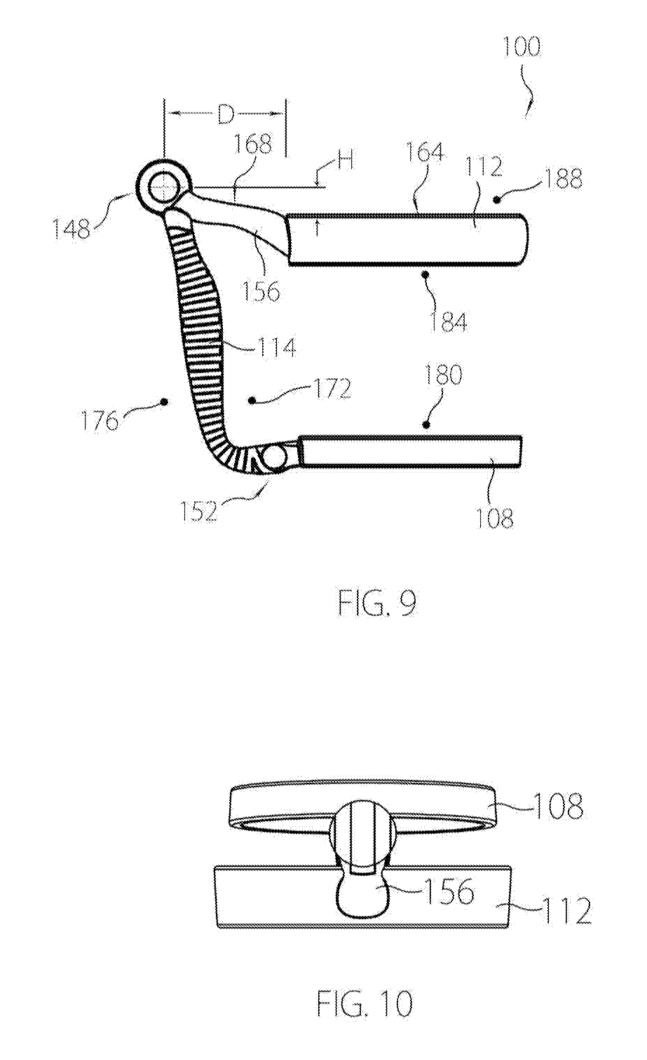

With particular reference now to FIG. 9, a preferred embodiment of a handle assembly 100 includes an extension member 156 configured to dispose an axis of rotation 160 of hinge 148 at an enhanced remote location (indicated by distance H) on an opposite side of a plane 164, defined by structure of the top surface of the holder, from the anchor 108. It is also preferred to offset rotation axis 160 of top hinge 148 by a distance D that is larger than the offset of the corresponding rotation axis of lower hinge 152.

The construction illustrated in FIG. 9 provides an angled member 156 that is configured in harmony with the handle 114 to permit a user to apply thumb pressure, from a hand that is gripping the handle 114, on a top surface 168 of the angled member 156 effective to cause the anchor 108 and the holder 112 to apply an auxiliary clamping torque on an installed container or cup 104. That may be beneficial, for example, to resist decoupling a cup 104 from the assembly 100 when tossing out dregs from the cup 104. As a further consequence, a strictly ornamental appearance, resembling a bird perched on the anchor 108 and carrying the holder 112 on its beak tip, may be created.

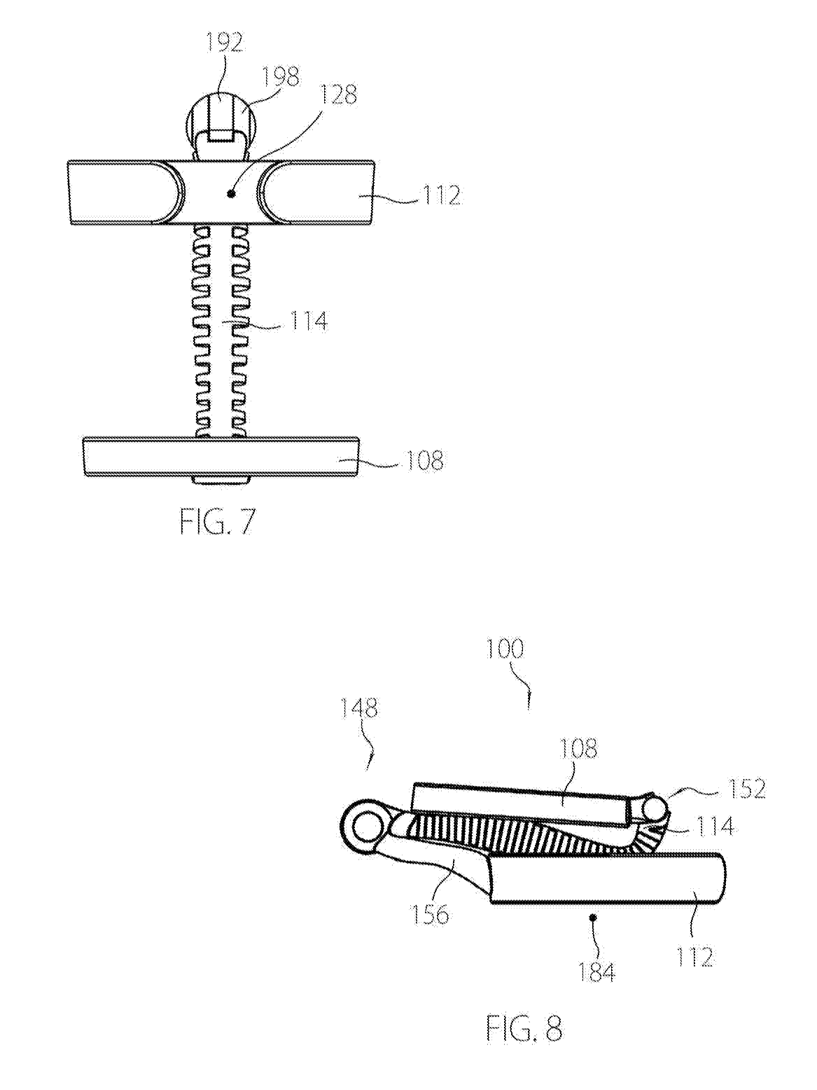

As illustrated between FIGS. 8 and 9, a preferred embodiment 100 orients anchor 108 and holder 112 substantially in parallel at both the stored and deployed configurations.

FIG. 16 illustrates handle 114 and anchor 108 structure of a preferred embodiment 100 disposed in a plurality of intermediate positions (in dashed lines) between a deployed configuration (in solid lines) and a stored configuration. With reference to FIG. 17, anchor 108 of the embodiment illustrated in FIG. 16 may rotate through an angle of about 110 degrees from a deployed configuration to a stored configuration. Also, holder 112 of the embodiment illustrated in FIG. 16 may rotate through an angle of about 286 degrees from a deployed configuration to a stored configuration.

In preferred embodiments, the hinge 148, hinge 152, and handle 114 are structured to permit a user to collapse a handle assembly 100 from a deployed configuration to a stored configuration such that the holder 112 is disposed on one side 172 of the handle 114 at the deployed configuration and is disposed on the opposite side 176 of the handle 112 at the stored configuration, and the assembly 100 occupies a minimum volume at the stored configuration. Also, holder 112 is on the same side 180 of the anchor 108 at both the stored configuration and the deployed configuration, but the anchor 108 is on the one side 184 of the holder 112 at the stored configuration and is on the opposite side 188 of the holder 112 when the anchor 108 is at the deployed configuration (see, e.g., FIGS. 8 and 9).

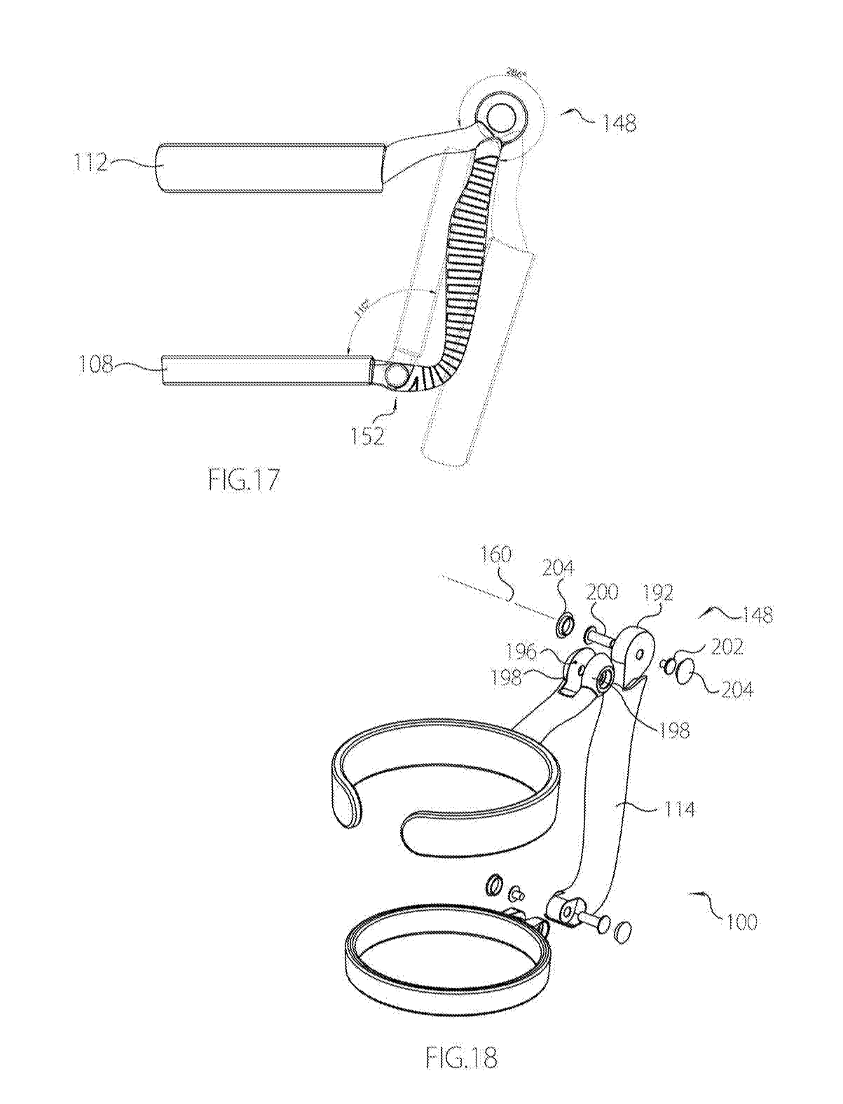

Construction of a preferred and exemplary hinge 148 is illustrated in FIG. 18. The illustrated hinge 148 may be characterized as a tongue-and-groove pinned joint structure, including tongue 192 received in groove 196. A groove 196 may be formed between cooperating sides 198. Either of the tongue and groove structure may be carried by any one of the handle or holder or anchor. Any of such and alternative structures providing similar and/or operable functionality may be considered to constitute a connector structure.

It should be realized that any workable hinge structure may be employed in alternative embodiments, including a simple single-lap joint (not illustrated). A fastener 200 and its cooperating anchor 202 may define rotation axis 160. It is currently preferred to provide decorative covers 204 to conceal axle structure of a hinge from casual sight of a user. Covers 204 may sometimes be made a color contrasting from handle 114 to further augment a decorative appearance of assembly 100.

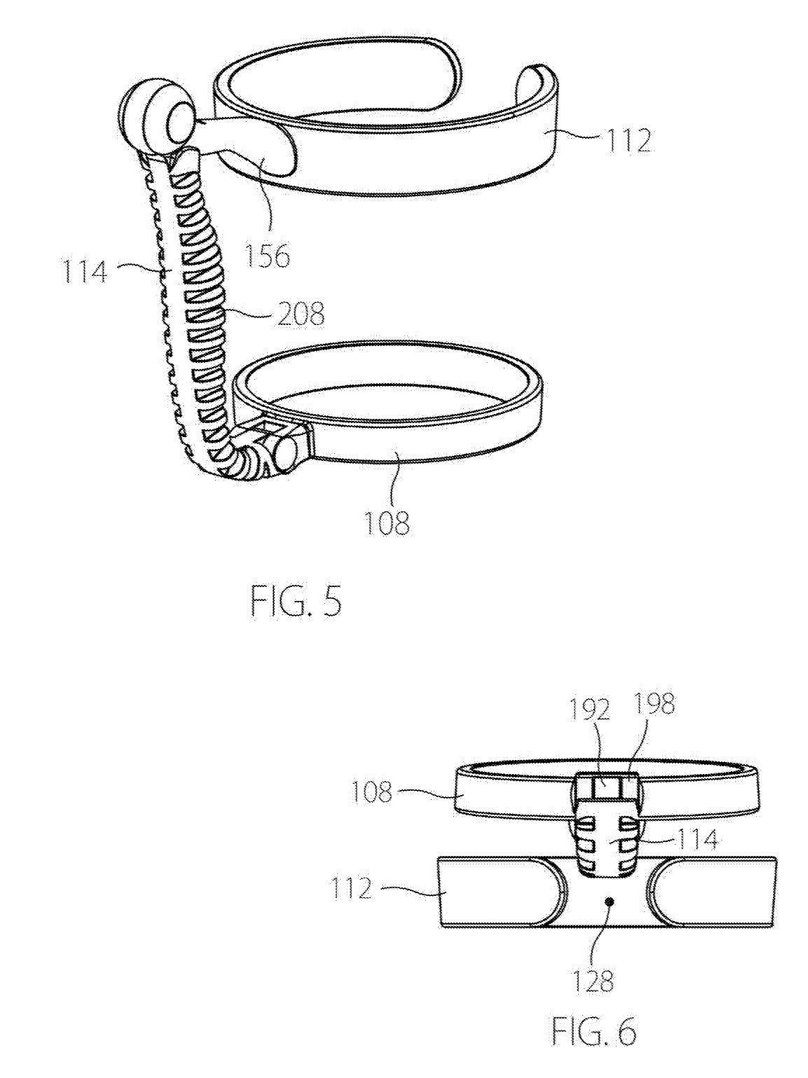

One currently preferred handle 114 includes a textured surface structured to reduce slipperiness when gripped in a user's hand. As illustrated in FIGS. 1-17, an operable textured surface includes a plurality of parallel ribs 208 (see especially FIG. 5) distributed along a length axis of the handle 114.

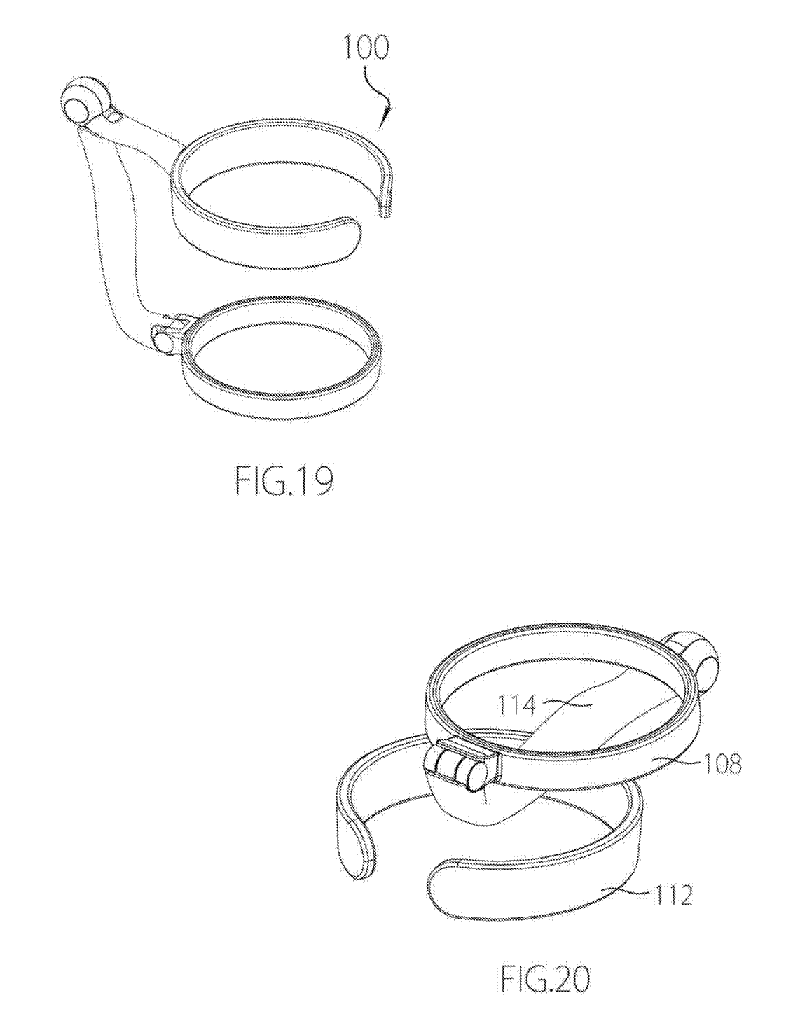

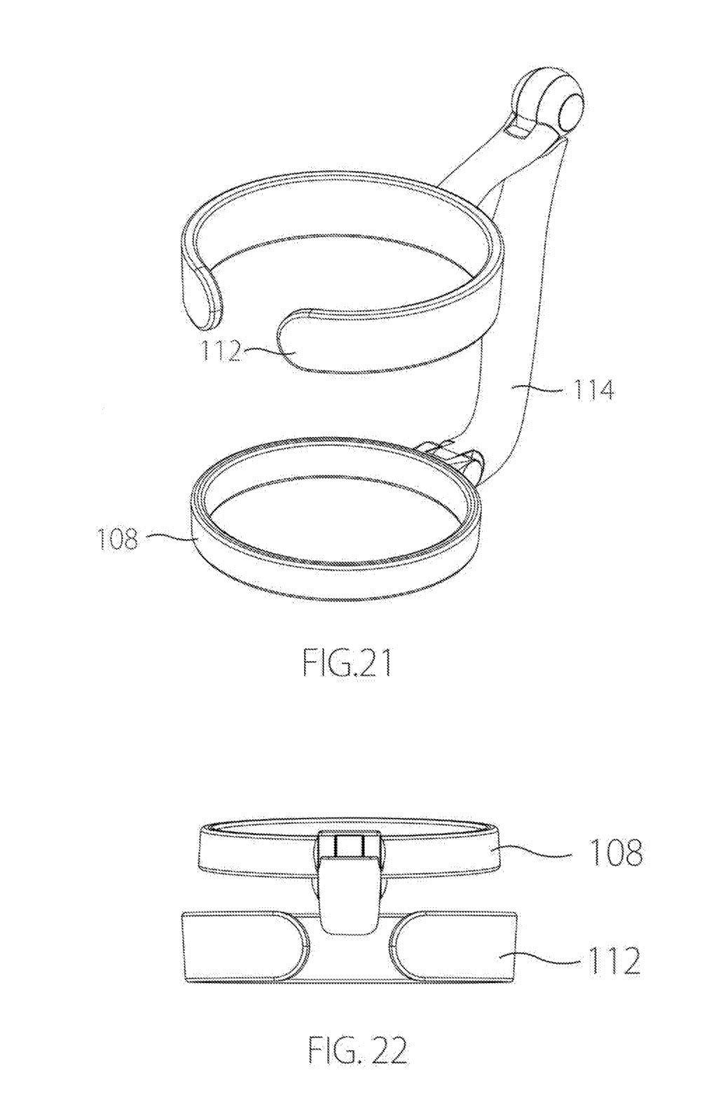

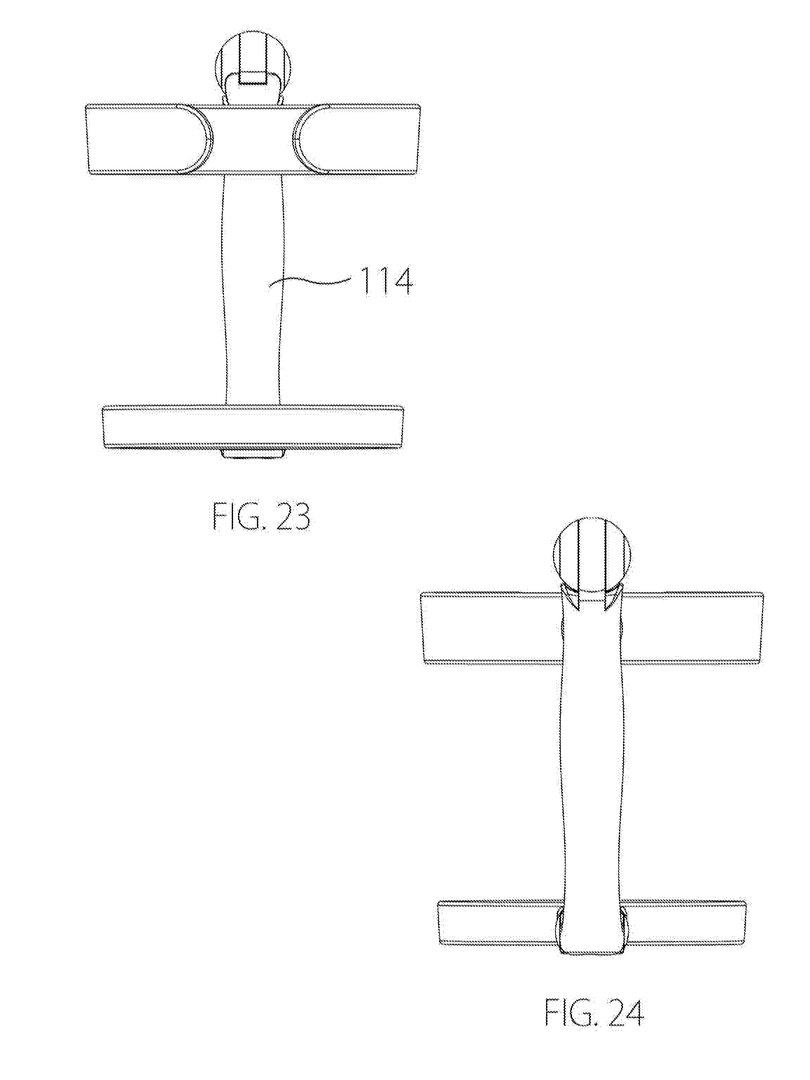

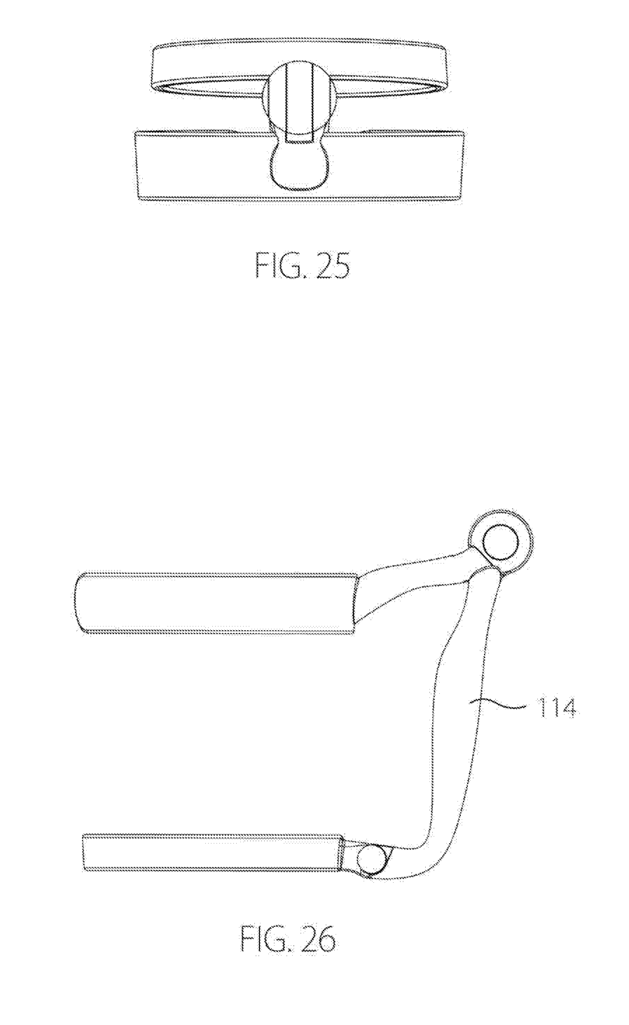

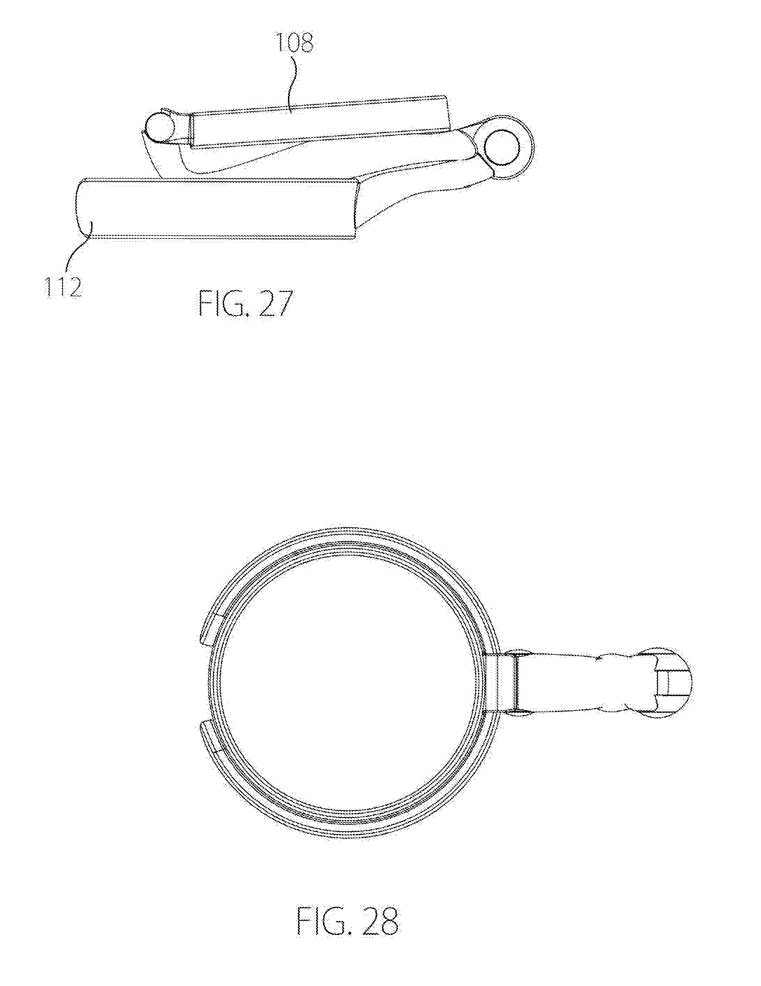

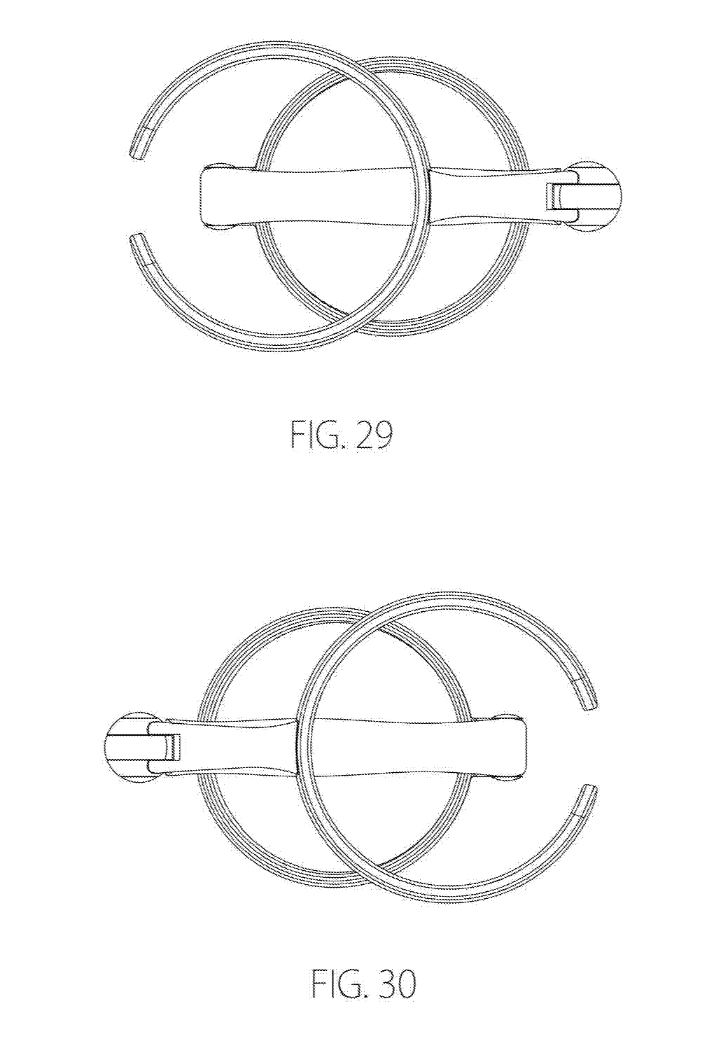

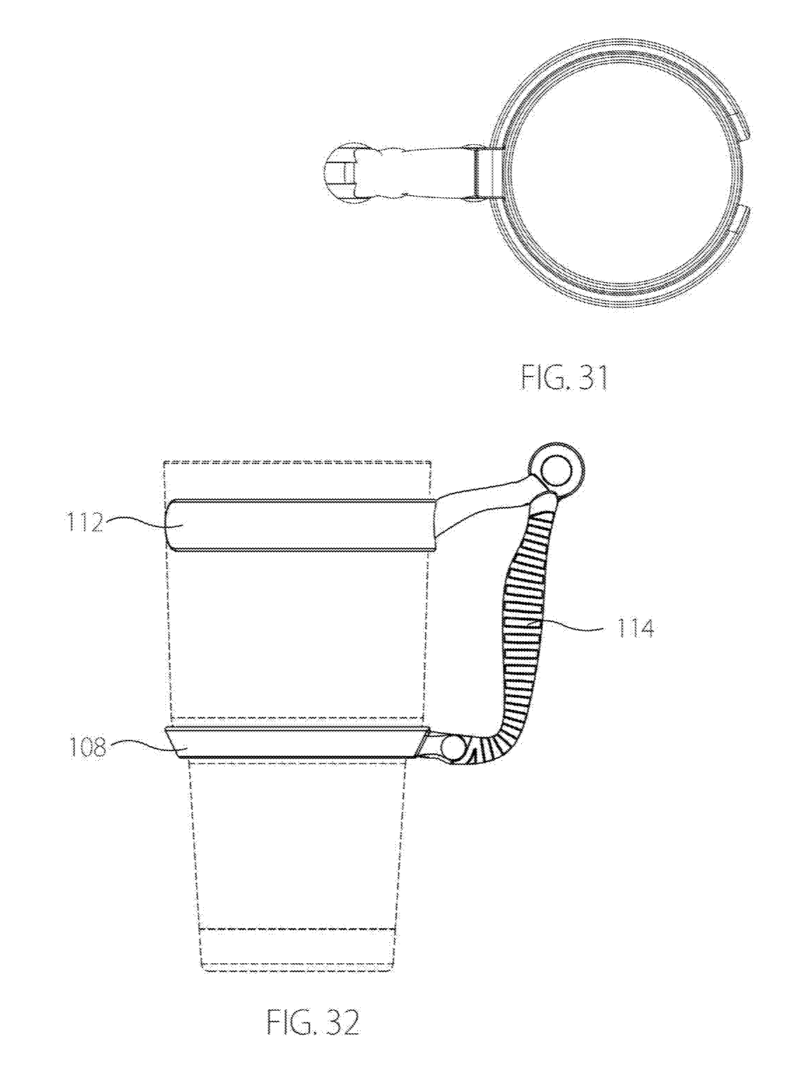

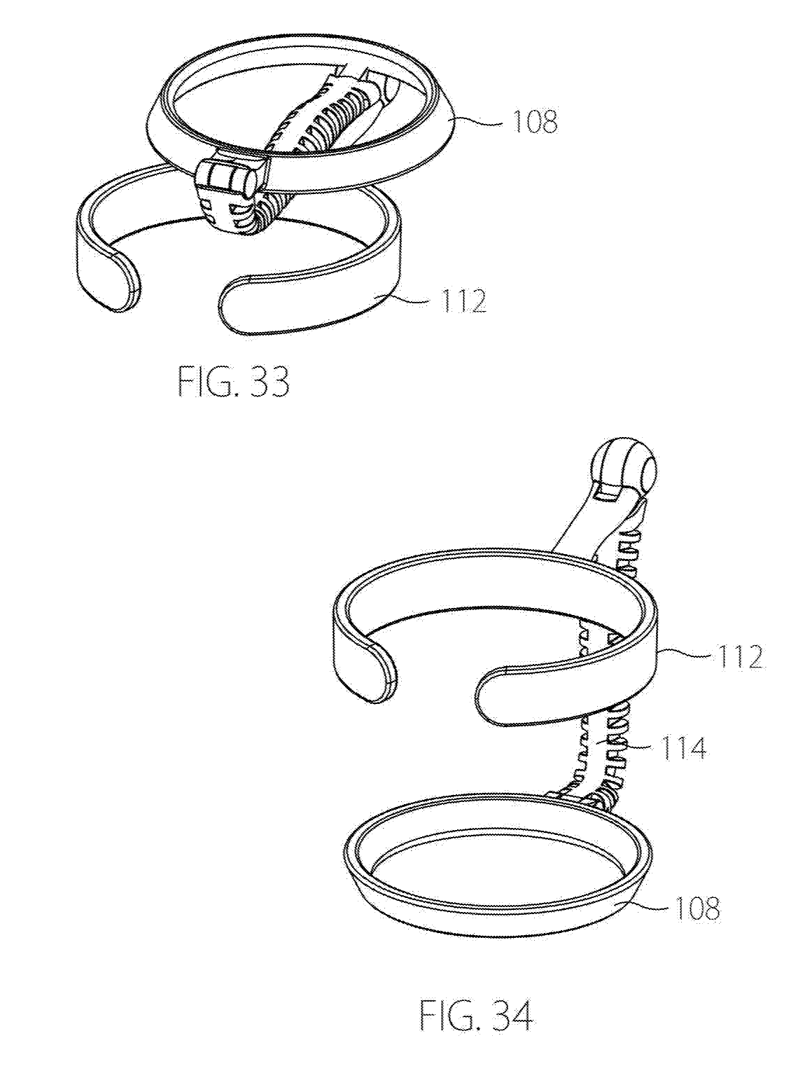

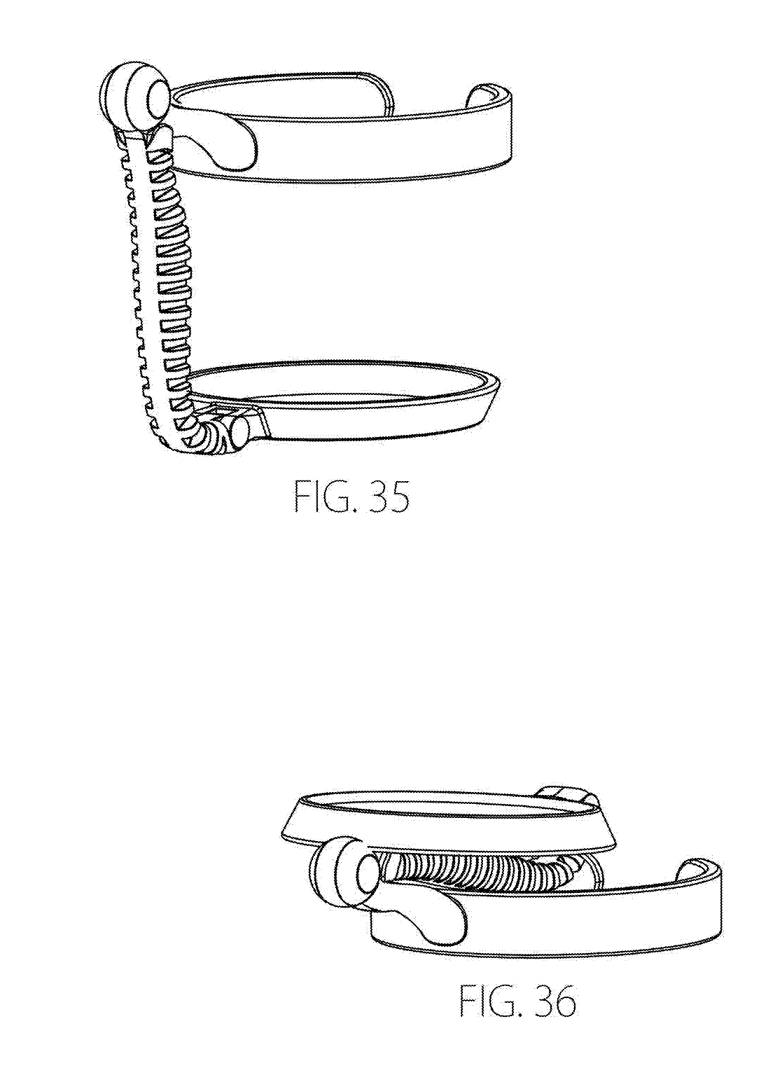

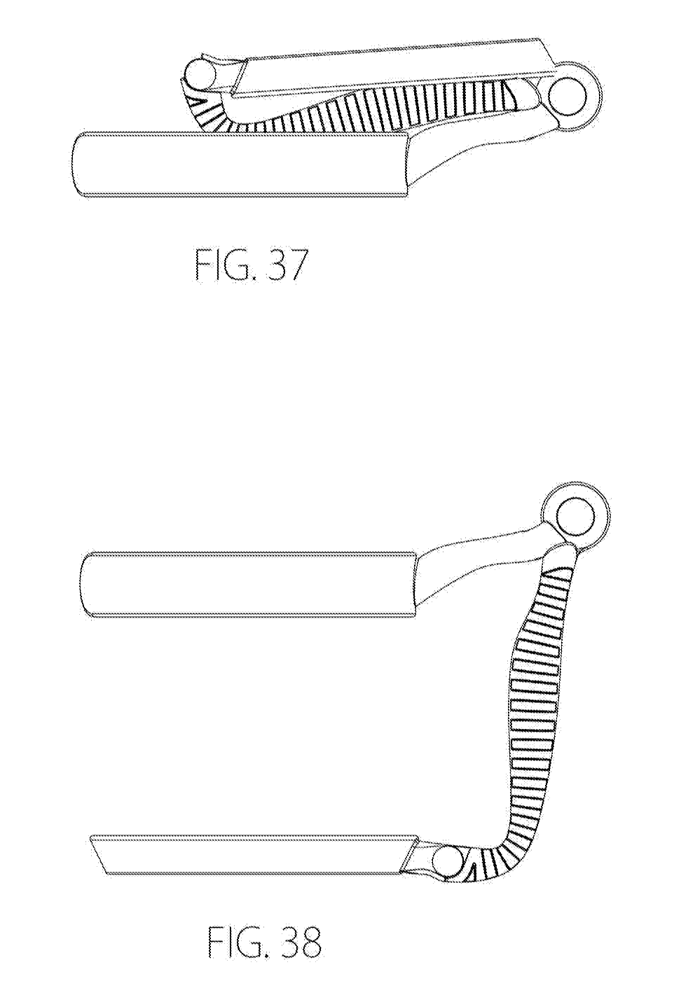

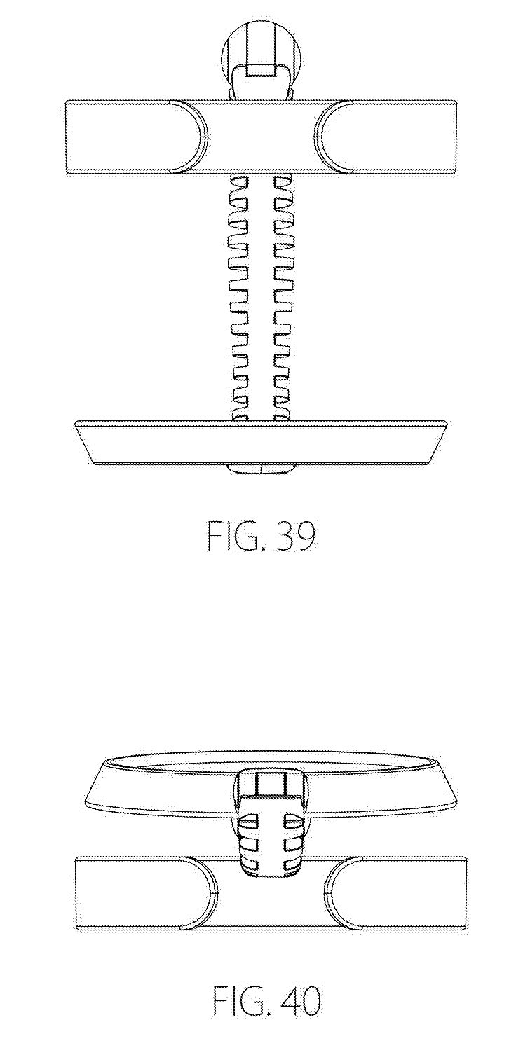

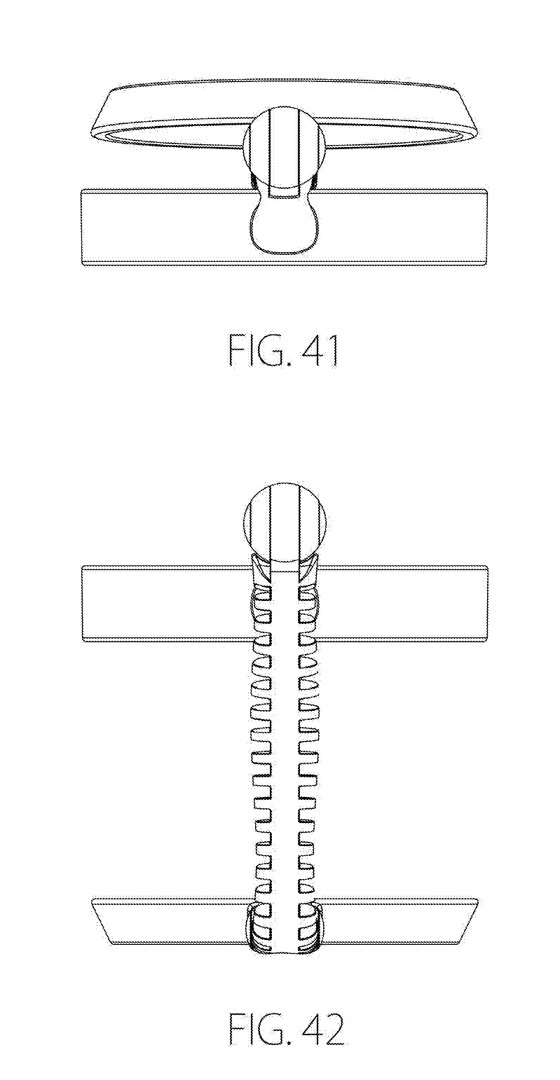

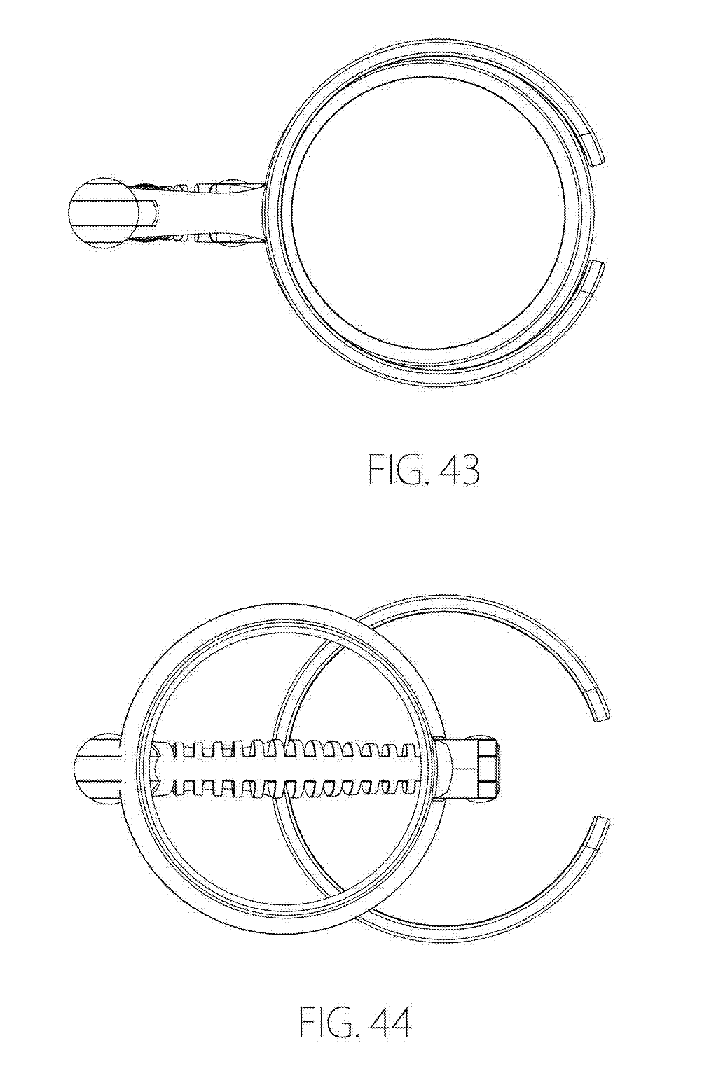

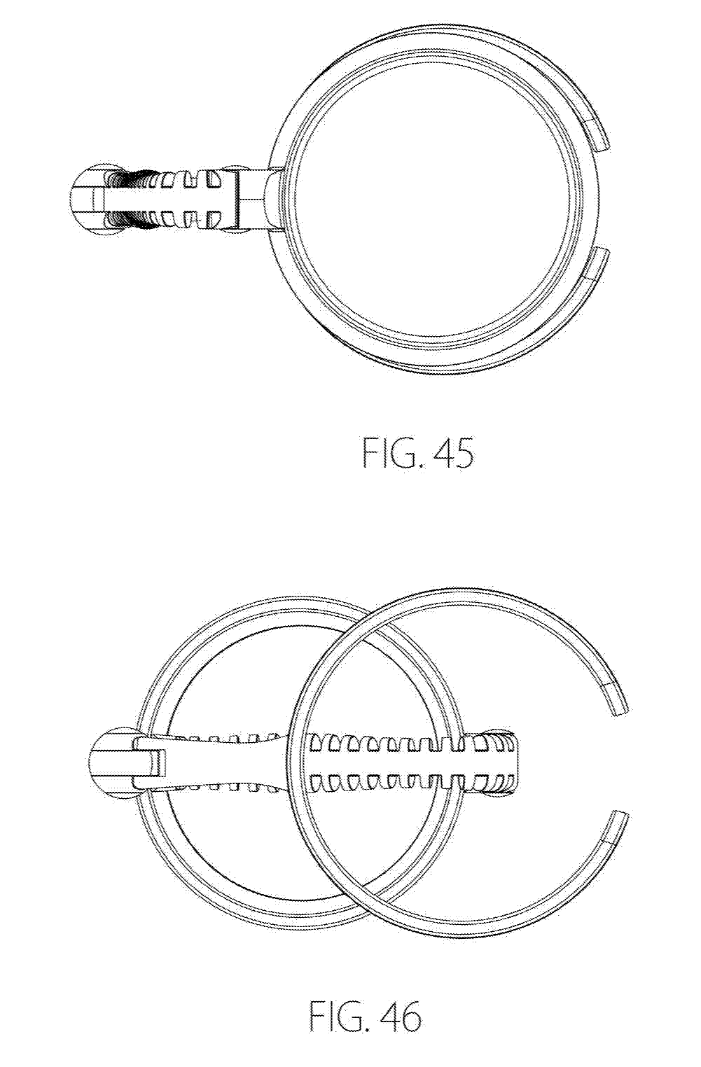

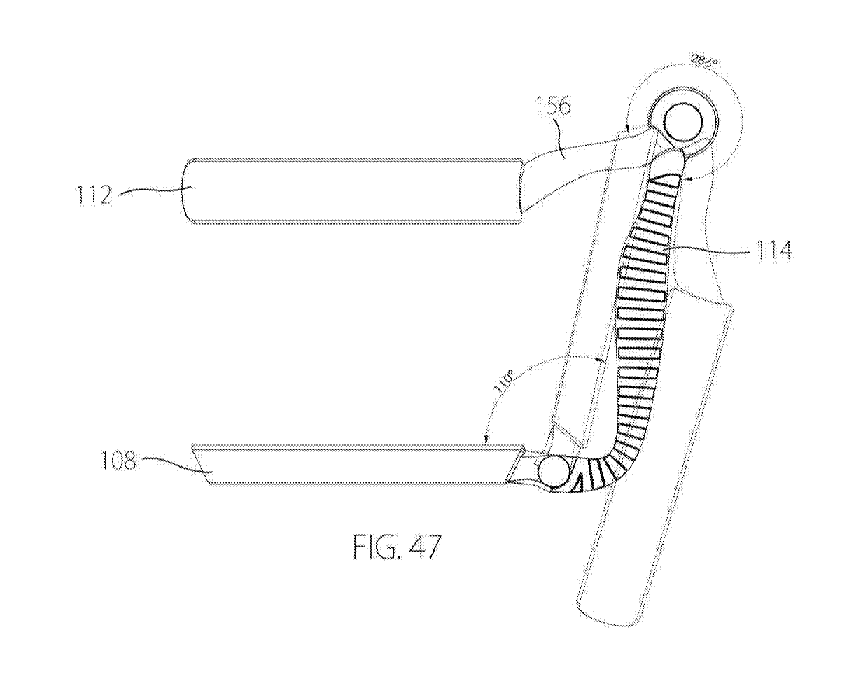

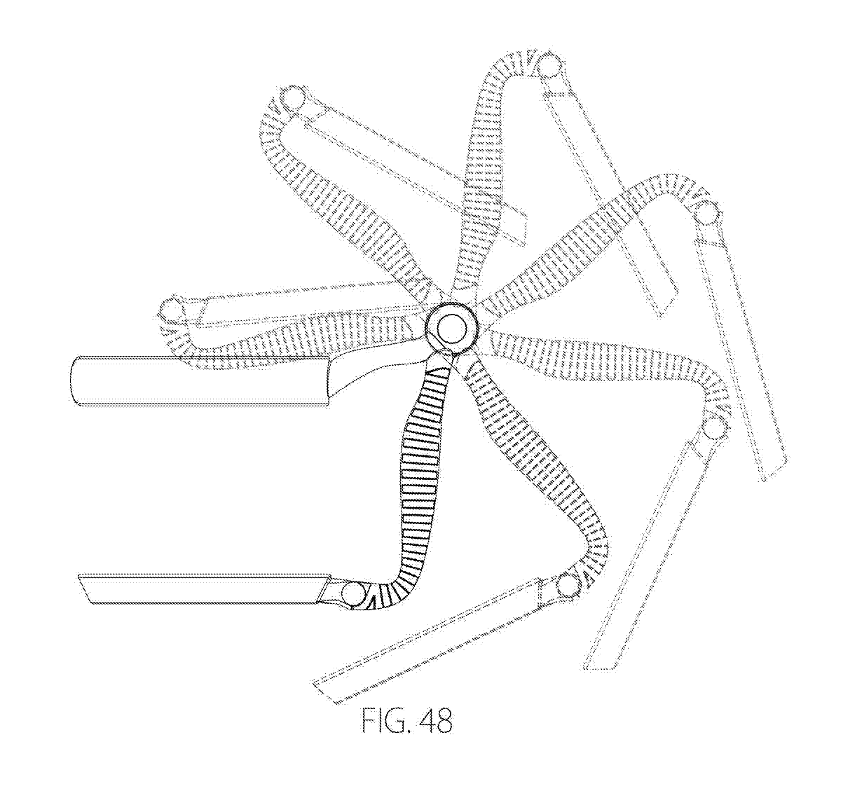

An alternative embodiment 100 featuring a generic and smooth handle 114 is illustrated in FIGS. 18-31. Another alternative embodiment featuring a different arrangement for anchor 108 is illustrated in FIGS. 32-48.

While the invention has been described in particular with reference to certain illustrated embodiments, such is not intended to limit the scope of the invention. The present invention may be embodied in other specific forms without departing from its spirit or essential characteristics. The described embodiments are to be considered as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
an anchor carrying a first connector, the anchor being structured to removably couple with a container at a first location;
a holder carrying a second connector, the holder being structured to removably couple with the container at a second location that is spaced apart from the first location;
a handle having a first end and a second end, structure carried at the first end being configured and arranged in harmony with the first connector to form a first hinge, structure carried at the second end being configured and arranged in harmony with the second connector to form a second hinge, wherein:
the first hinge, second hinge, and handle are structured to permit a user to collapse the apparatus from a deployed configuration to a stored configuration such that the holder is disposed on one side of the handle at the deployed configuration and is disposed on the opposite side of the handle at the stored configuration, and the apparatus occupies a minimum volume at the stored configuration.

2. The apparatus according to claim 1, wherein:
the holder is on the same side of the anchor at both the stored configuration and the deployed configuration; and
the anchor is on the one side of the holder at the stored configuration and is on the opposite side of the holder when at the deployed configuration.

3. The apparatus according to claim 1, wherein:
the deployed configuration occupies a larger volume than the stored configuration.

4. The apparatus according to claim 1, wherein:
the holder is approximately parallel to the anchor at both the deployed configuration and the stored configuration.

5. The apparatus according to claim 1, wherein:
the first hinge comprises a tongue-and-groove pinned joint.

6. The apparatus according to claim 1, wherein:
the second hinge comprises a tongue-and-groove pinned joint.

7. The apparatus according to claim 1, wherein:
the anchor comprises a stop element defining an uninterrupted first perimeter, the stop element being structured to resist displacement of the container in a direction away from the holder; and
the holder comprises a gripping element defining an interrupted second perimeter, the gripping element being resilient to deflect and enlarge a size of the gripping element to accommodate containers having different sizes.

8. The apparatus according to claim 7, wherein:
an opening in the second perimeter is disposed opposite the handle.

9. The apparatus according to claim 1, wherein:
the anchor comprises a circumferentially continuous first ring element; and
the holder comprises a circumferentially-interrupted second ring element, the second ring element being resilient to deflect and enlarge an inside diameter of the second ring element to accommodate containers having different sizes.

10. The apparatus according to claim 7, wherein:
the holder has elasticity to permit a user to cause a bias in the holder, and thereby, generate a compression force at a contact interface area between the holder and an installed container.

11. The apparatus according to claim 10, wherein:
the bias is a bending moment that causes substantially uniform pressure to be distributed over the contact interface area.

12. The apparatus according to claim 1, further comprising:
an angled extension member extending between the holder and the second hinge effective to dispose the second hinge at an enhanced remote location on an opposite side of a plane, defined by structure of the top surface of the holder, from the anchor.

13. The apparatus according to claim 1, wherein:
the handle comprises a textured surface structured to reduce slipperiness when gripped in a user's hand.

14. The apparatus according to claim 13, wherein:
the textured surface comprises a plurality of parallel ribs distributed along a length axis of the handle.

15. The apparatus according to claim 1, further comprising:
a decorative cover adapted to conceal axle structure of the first hinge and/or the second hinge from casual sight of a user.

16. The apparatus according to claim 12, wherein:
the angled member is configured in harmony with the handle to permit a user to apply thumb pressure, from a hand that is gripping the handle, on a top surface of the angled member effective to cause the anchor and the holder to apply an auxiliary clamping torque on the container.

17. The apparatus according to claim 1, wherein:
the anchor is structured for rotation between deployed and stowed configurations, and with respect to the handle, by an angle comprising about 100 degrees.

18. The apparatus according to claim 1, wherein:
the holder is structured for rotation between deployed and stowed configurations, and with respect to the handle, by an angle comprising about 280 degrees.

19. In a removable handle assembly that can be applied to a drinking vessel to make a mug, the improvement comprising:
a top holder defining a first interior space in which to receive the drinking vessel by inserting the drinking vessel in a direction parallel to a length axis of the drinking vessel, the top holder carrying an angled extension member configured to dispose a top hinge above a plane defined by structure of the top surface of the top holder;
a bottom anchor structurally associated with a bottom hinge, the bottom anchor being configured to resist displacement of the drinking vessel beyond an installed position and in a direction way from the top holder; and
a handle connected between the top hinge and the bottom hinge.

20. The apparatus according to claim 19, wherein:
the top hinge, bottom hinge, and handle are structured to permit a user to collapse the handle from a deployed configuration to a stored configuration such that the top holder is disposed on one side of the handle at the deployed configuration and is disposed on the opposite side of the handle at the stored configuration, and the handle assembly occupies a minimum volume at the stored configuration.
